(19) United States
(12) Patent Application Publication
(10) Pub. No.: US 2004/0153337 A1
(43) Pub. Date: Aug. 5, 2004

(54) Automatic authorizations

(76) Inventor: Guille B. Cruze, Knoxville, TN (US)

Correspondence Address: LUEDEKA, NEELY & GRAHAM, P.C., P O BOX 1871, KNOXVILLE, TN, 37901, US

(21) Appl. No.: 10/358,516

(22) Filed: Feb. 5, 2003

(51) Int. Cl. G06F 17/60

(52) U.S. Cl. 705/2

(57) ABSTRACT

A user inputs information identifying a person and the user. A computer system analyzes the user's voice to verify or determine the user's identity, and allows only valid users to access the system. The input information is compared to benefits information stored in the system to make automatic determinations concerning the benefits, and those determinations are transmitted to the user. The user is prompted to provide information in a format specified by the user and receives information in a format specified by the user. Other users, such as benefit organizations, also receive information in a format that they specify. When automatic authorization (or communication) by a facilitator computer is not appropriate, information is transmitted to a benefit organization computer, and further computer analysis or manual analysis is performed, and determinations concerning benefits are transmitted to the user. In a preferred embodiment, the user inputs diagnosis codes and action codes, and either a facilitator computer or a benefits organization computer or a benefits organization operator makes the determination that is sent to the user.

### FIELD

The present invention relates to information transfer systems for use in one or more organizations where one group provides services and another group provides benefits, and particularly relates to an information transfer system used to transfer information between health care providers and health care organizations such as managed care organizations or insurance companies.

### BACKGROUND

In one or more organizations where one group of people provides services and another group provides benefits, there is a need to communicate information between the service providers and the benefit organization. One example of such an organization would be the health care organization of the United States. Typically there are numerous service providers such as doctors and hospitals, and there are numerous benefit organizations such as managed care organizations, preferred care organizations, and health insurance companies. The providers need to communicate with the benefit organizations because the benefit organizations suggest or require such communication and some organizations impose severe penalties for not properly communicating with the benefit organization. For example, some managed care organizations will deny benefits for a health care action if pre-authorization (or pre-certification) is not obtained prior to performing the health care action. As used herein the word “action” is used in a broad sense to include medical or diagnostic procedures, hospital stays or services, services of other patient care facilities, and other service or care that may be provided to or for a person or entity.

Numerous systems exist for providing a communication link between the providers and the benefit organizations. The providers may manually telephone the benefit organization, but a manual telephone call is typically very inefficient for busy providers and busy benefit organizations. Sophisticated voice mail systems greatly improved the efficiency of telephone communications, but such communications are still relatively inefficient and costly for both the provider and the benefit organization. Other forms of communications also exist. For example many benefit organizations provide Web pages where a service provider such as a nurse can obtain information and can request pre-authorization for a particular service action. However, security concerns complicate the access to Web pages. For example, some benefit organizations require a service provider to attach physical keys or dongles to their computer in order to access a web page. If a nurse, for example, needed to access numerous Web pages for numerous benefit organizations, he, would be required to have numerous physical keys and would be required to insert the physical keys into his computer to obtain access to a particular Web site. For a busy nurse, the process of using physical keys is cumbersome. Likewise, security measures involving user names and passwords can be cumbersome and insecure.

Thus, there exists a need for improved communication systems between service providers and benefit organizations. As used herein, the term “organization” is used in a broad sense. An organization can be a government, a legal entity such as a corporation or an insurance company, groups of legal entities, or informal organizations such as divisions or groups within a company. The need to communicate between all of these types of organizations is great. For example, many large organizations operate internally in a manner somewhat similar to the operation of the entire health care organization of the United States. Both types of organizations have similar needs for efficient transfer of information.

### SUMMARY

In accordance with the present invention, an information transfer system for transferring information about a person from and to a user includes user inputs enabling the user to input information into the information transfer system. The information corresponds to at least an identification of the person and an identification of the user. At least one computer system receives information from the user inputs and identifies the user, producing user identification based on the information. The computer system also identifies the person and produces person identification based on the information. Benefits information corresponding to persons' benefits provided by at least one organization is stored in the computer system, and the person identification is compared to the benefits information to make automatic determinations for the person concerning the benefits provided by the at least one organization for the person. A computer system output automatically transmits the automatic determinations to the user concerning the benefits for the person. In accordance with an aspect of this embodiment, the computer system may store benefits information for a plurality of organizations and a plurality of persons, and may make automatic determinations concerning benefits for particular persons for a plurality of organizations. These automatic determinations for the plurality of organizations are transmitted back to the user by the computer system output.

In accordance with a more specific embodiment of the present invention, an information transfer system includes provider inputs and at least one voice enabled computer system. The information transfer system is designed for transferring information about a person to and from a service provider, such as a health care service provider, for example. Provider inputs enable the provider to input at least voice information into the system, and the voice information typically corresponds to the identification of a person receiving service and the identification of the provider, and it can include other information. The provider input transmits this information to the voice enabled computer system.

After receiving the voice information and possibly other information from the provider, the voice enabled computer system identifies the provider and the person receiving services based on the voice information. Coverage information is stored in the voice enabled computer system corresponding to the eligibility of persons for benefits provided by an organization. For example, such coverage information may include a description of the eligibility and health-care benefits provided to a particular person by a particular managed care organization. As another example, such coverage information may include a description of the eligibility and benefits provided by a private or public retirement system, such as a corporation retirement system, a government retirement system such as Social Security, or Medicare. The person's information is compared to the coverage information and eligibility information is determined indicating whether a particular person is eligible for benefits. A computer system output transmits the eligibility information to the provider indicating whether the person is eligible for benefits.

In one embodiment, the provider inputs voice information corresponding at least to a diagnosis of the person and a proposed service action. The computer system compares the person information to the coverage information and produces automatic authorization information indicating whether the proposed service action is authorized. The computer system transmits the authorization information to at least some providers for at least some proposed actions, automatically. The automatic authorization may occur because no authorization is required or because the person information justifies the proposed action based on authorization criteria. (As used herein, the word “or” is used in its broadest sense as a logical operator meaning one or another or both or others or all.) The voice enabled computer system may determine that automatic authorization is not appropriate based on the authorization criteria. In such case the computer system automatically transmits the authorization information to the organization that provides the benefits.

In a further embodiment, the voice enabled computer system prompts the provider for information in a format previously specified by the provider and generates output information for the organization and the provider in a format previously specified by the organization and the provider, respectively. Thus, the provider and the organization send and receive information in a format most convenient for them.

In accordance with another embodiment, a voice computer system receives voice messages from a provider and converts at least some of those voice messages to text. A facilitator computer system stores user profiles that contain information about the providers and the persons for whom benefits are provided by the organization. Information is transferred between the two computer systems, the facilitator computer system and the voice computer system, by a communication link. The facilitator computer system receives information from the voice computer system corresponding to the voice messages including at least the text and processes the text to identify at least the person and produces person information based on the identity of the person and the information stored in the user profiles.

In accordance with an aspect of this embodiment, the facilitator computer system may also communicate with an organization computer system through the communication link. The organization computer system stores information about persons including coverage information for each person. The facilitator computer system receives information from the organization computer system including person information and coverage information through the communications link. The information received by the facilitator computer system is stored to allow it to perform the aforementioned functions. When the organization computer system receives person information from the facilitator computer system, it may update a database using the received information and it may compare and analyze the received information. For example, it may determine whether the person information corresponds to a person in its data base who has benefits with the benefit organization. Also, the received information may be displayed visually and played aurally for a user. In this manner a user may manually examine the received information and make a determination as to whether the person is entitled to benefits and, if so, it may further determine the nature and extent of the benefits available to this particular person.

In accordance with the another aspect of the various embodiments, the voice enabled computer system may include a voice storage module for storing voice signatures corresponding to the voices of providers who use the system. A voice analysis module is also provided to compare the voice of a particular provider to the voice signatures and thereby make a determination concerning the identity of the provider. The comparison may be made in several ways. For example, the voice enabled computer system may be provided with a number, such as a personal identification number, or PIN, that identifies the particular provider who is speaking. The PIN may be provided by speaking each number, or it may be provided by pushing buttons, such as the buttons of a push button phone. If the PIN is provided by spelling out each number, the voice computer converts the voice to text form. Using the number that identifies the provider who is speaking, a particular voice signature may be selected for comparison to the voice of the particular provider who is calling. This type of comparison provides verification of an already identified provider.

Another way to use the stored voice signatures is to compare the particular provider's voice to the stored voice signatures and determine whether the provider's voice matches any of the stored voice signatures. If an acceptable match is found, the provider is identified and allowed access to the system. If no acceptable match is found, the provider or caller is denied access or further processed to determine in other ways whether access will be granted.

### BRIEF DESCRIPTION OF THE DRAWINGS

The present invention may best be understood by reference to example embodiments shown in the attached drawings in which:

FIG. 1 is a schematic diagram of an information transfer system which illustrates multiple embodiments of the invention;

FIG. 2 is a flow chart illustrating a main program enabling a user to select either a benefits routine or a pre-certification routine;

FIG. 3 is a flow chart illustrating a software routine to verify voices or identify voices;

FIG. 4 is a flow chart illustrating a benefits routine for verifying eligibility for health care benefits provided by a benefit organization;

FIG. 5 is a flow chart illustrating a pre-certification routine for pre-certifying or authorizing an action, preferably, using diagnosis codes and CPT codes in the health-care field;

FIG. 6 is a continuation of the flow chart shown in FIG. 5; and

FIG. 7 is a flow chart illustrating a benefit organization routine under which a benefit organization responds to a user or provider.

### DETAILED DESCRIPTION

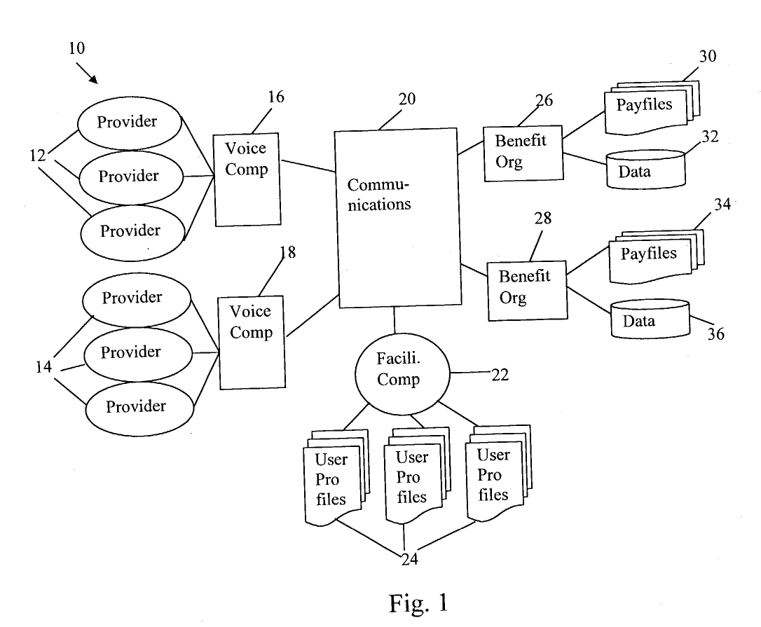

Referring now to the Figures in which like reference characters refer to like or corresponding parts throughout the several views, there is shown in FIG. 1 an information transfer system 10 illustrating a high level overview of one embodiment. In FIG. 1, a first plurality of providers 12 and a second plurality of providers 14 are shown. The providers of 12 and 14 represent the many providers that would typically use the information transfer system 10. Providers 12 communicate with a voice computer 16 and providers 14 communicate with a voice computer 18. The communication between the providers 12 and 14 and the voice computers 16 and 18 is preferably by telephone, but it could also involve the use of voice communications and data communications by computer systems, networks, Internet, wireless voice communication, wireless data communication, and other communication systems.

The voice computers 16 and 18 are programmed to receive voice information and record voice files. The computers 16 and 18 may also receive data in the form of digital data from other computers, and digital data from the telephone such as the called number and the caller's number. The digital data and the voice information may be further processed to generate additional information or data. For example, the voice information may be processed to interpret and convert the voice information to digital data such as alphanumeric text. All of the data received by the voice computers 16 and 18 may be compared with stored data in the computers 16 and 18 and additional data may be generated by that comparison.

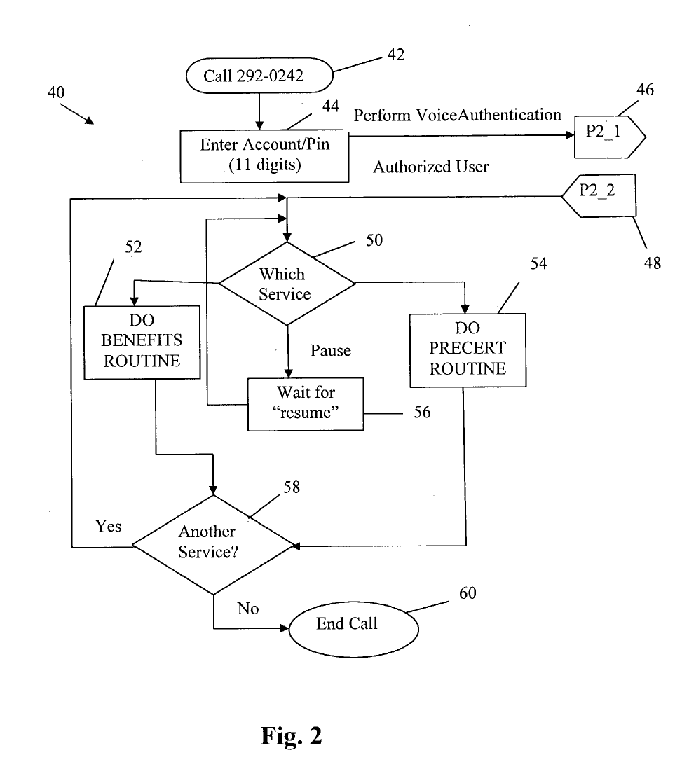

The voice computers 16 and 80 communicate through a communications link with facilitator computers 22. Typically the system 10 will include numerous facilitator computers 22 and it will be understood that the facilitator computer 22 shown in FIG. 2 represents a plurality of computers. A plurality of user profiles 24 are stored in each facilitator computer 22. Data, including voice information and digital data, is transferred from the voice computers 16 and 18 to the facilitator computer 22 for further processing. The user profiles 24 include information about the users, who are the providers 12 and 14, such as the identity of a particular provider 12 and his or her preferences. Typically a user profile would include information such as the name and address of the provider, and the telephone numbers, fax numbers, e-mail addresses, private passwords, and PINs for the providers 12 and 14. In addition, the user profiles 24 would include preferences for the order of information that is typically transferred by the provider to the system 10. For example, if the system 10 is being used by physicians, the user profiles 24 would include prompting instructions for a particular provider 12 that would prompt for information about a patient in a particular order. The facilitator computer 22 would also typically have the capability in most embodiments to either verify or identify the providers 12 and 14 by analyzing their voices and comparing the voices to voice signatures stored in the user profiles for each of the providers 12 and 14.

The facilitator computers 22 communicate with benefit organization computers 26 and 28 through the communication link 20 and information is transferred in both directions. Benefit information, person information, and historical information is stored by the computers 26 and 28 in pay files 30 and 34 and data files 32 and 36. Benefit information specifies the types and scope of benefits available for a person. The person information identifies a person with such information as name, address, Social Security number, and other identification numbers such as a PIN, telephone numbers, e-mail addresses, providers with whom the person is associated, and correlation information that correlates the person information to the benefit information and historical information. The historical information in a preferred embodiment includes general historical information concerning past benefit information and changes in the general benefit information, and it would include specific benefit information for specific persons, which would include a benefit history relating to the various benefits provided to a specific person over time.

In general, the pay files 30 include information specific to a particular person, and the data files 32 and 36 include information that is general, and would relate to a number of different persons. However, the information can be distributed in other ways between the pay files 30 and 34 and the data files 32 and 36, or all of the information may be stored in one location or many multiple locations.

In a preferred embodiment, the providers 12 and 14 are health-care providers such as nurses, doctors and hospitals. The providers 12 and 14 are typically represented on a telephone by a nurse or a staff member of a hospital or doctor. The persons are patients, and the benefit information is coverage information corresponding to the type and scope of available insurance coverage or managed care coverage or preferred care coverage or a similar type of benefit provided by an organization in the health-care industry.

In FIG. 1, the voice computers 16 and 18, the communications link 20, the facilitator computers 22 and the benefit organization computers 26 and 28 are illustrated for clarity as individual separate elements. However, individual ones of these elements may be combined into one element or all of these elements may be combined into one single element. That is, all of the functions of the aforementioned elements could be performed by a single computer system having communications capability.

Having described the overall information system 10 in general, a description of a specific embodiments relating to health care is provided below with reference to FIGS. 2-7. FIG. 2 illustrates a flow chart 40 for an information system 10 used in the health-care industry to verify eligibility for benefits and to pre-certify (or pre-authorize) a health care action for a patient. To begin the process, at step 42 a nurse or other staff person makes a telephone call to a computer, such as voice computers 16 shown in FIG. 1. When the telephone call is placed, the “ring signal” will include the called number and the caller number. The voice computer 16 may use both numbers to identify the caller and begin processing. The caller number is typically used to identify the provider who is calling, and the called number is typically utilized to identify additional information about the service that will be requested by the provider 12.

For example, the provider 12 may have one number that is called when the provider is seeking to determine eligibility information only, and it will have another number that is called when the provider 12 is seeking pre-certification. Both numbers will actually call the same voice computer 16, but the different called numbers will quickly indicate to the computer 16 the nature of the information or service that the provider 12 is seeking. As another example, the provider 12 may have a different number for each health-care benefit organization with whom it deals. Again, each of those numbers will call the same voice computer 16, but the called number will identify the organization that the provider is calling about, and the computer 16 may begin accessing the appropriate data files in its memory even before the call is answered.

When the computer 16 answers the phone, the computer 16 will move to step 44 and will prompt the caller to enter an account number and a PIN. The account number will typically identify a provider, such as a hospital or a doctor's office, and the PIN will identify the particular caller, such as a nurse from a doctor's office or a hospital staff person. These numbers may be entered by speaking each number individually or as a single number. For example if an account number is 1234, the caller may say “One two three four” or the caller may say “One thousand two hundred thirty-four.” The computer 16 will then convert the spoken words to a number and will thereby identify the account, which identifies the provider, and will identify the PIN, which identifies the specific caller.

The computer 16 then performs voice authentication or identification as indicated by a block 46. Assuming the user is authorized, the program resumes at block 48. It is recognized that security redundancy exists in the System 10, and it would be possible to eliminate the entry of a PIN and rely on the voice identification step to identify the caller and rely on the caller number to identify the provider. Likewise, if a high level of security is not desired, it would also be possible to eliminate voice identification/verification. However, in the health-care field, security is a primary concern because private information, namely patient information and records, are being transferred and accessed by the provider/user/caller.

In one embodiment, the computer 16 prompts the user to provide information and does not specify a format (natural speech, spell-out or otherwise). If the computer 16 cannot recognize the information it will prompt the user to spell-out the information (such as a number). That is, the computer 16 will ask the user to speak each number or character individually. If the number is still not recognized, the computer will request the user to speak out the whole number as a single number such as two million, five hundred forty three thousand, two hundred thirty two. If the number is still not recognized, the computer 16 may request the user to input the number using keypads on a phone. While this embodiment utilizes a particular order for requesting formats of spoken information, other orders and other formats and numbers of formats may be used.

Assuming the user has been authorized, the computer 16 then moves to decision block 50 and prompts the user to state which service is desired. The user then will state either “Benefits eligibility” or “Pre-certification requested.” The computer 16 listens to the user and picks one of the routines of 52 or 54 depending upon the computer's interpretation of the user's voice answer. Preferably, the computer 16 will tell the user which routine has been selected and will give the user an opportunity to change the routine that was selected. If a user fails to answer the question within a predetermined length of time, the program moves to step 56 and waits for any sound from the user. When the computer 16 recognizes sound from the user, it will ask the user again politely to identify which services it wishes to access.

Once a particular routine has been selected, either the benefits routine 52 or the pre-certification routine 54 will be performed. The benefits routine 52 is the quicker routine and simply answers the question as to whether a particular patient is eligible for benefits from a particular health care organization. If so, the benefits routine will provide benefits information to the provider which may include information as to co-pay requirements, deductibles and limits. If the pre-certification routine at step 54 is chosen, additional information must be provided by the user as hereinafter explained.

After steps 52 and 54, the computer 10 moves to the decision block 58 and prompts the user to state whether another service is requested. If the user answers “No” the computer program moves to step 60 and ends the call. If the user answers “Yes” the program of computer 16 returns to decision block 50 and begins again.

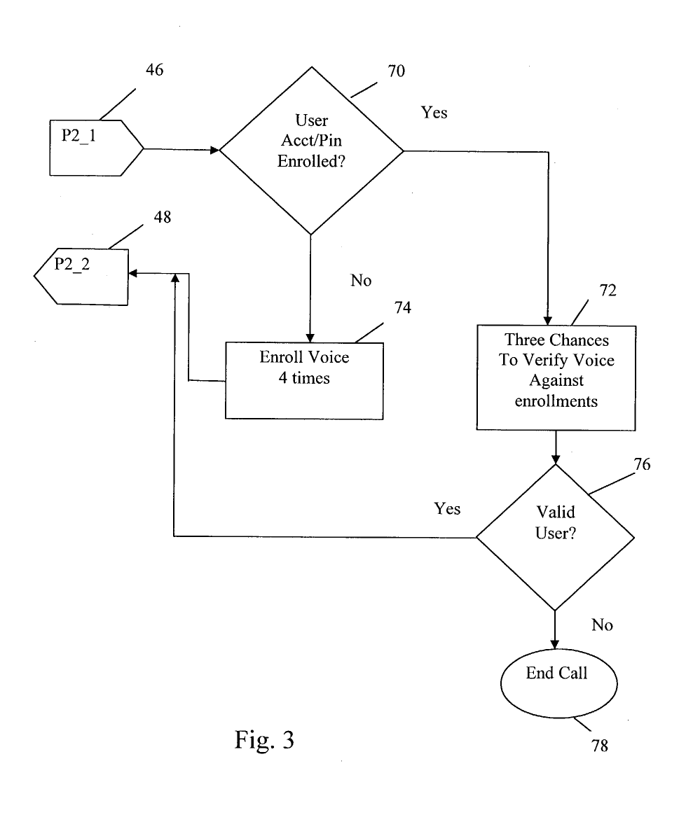

Referring now to FIG. 3, a flow chart illustrates the voice authentication or identification performed by the computer 16. Connection blocks 46 and 48 are shown in FIG. 3 to illustrate how the flow chart of FIG. 3 connects to the flow chart of FIG. 2. At step 70, the computer 16 performs a check to determine whether the user account number and PIN are enrolled in its records as a valid account and PIN. If the answer is “Yes” the program moves to step 72. If “No” the program moves to step 74. At step 72 the computer 16 compares or verifies the user voice against voice signatures stored in its records.

A variety of techniques may be used at this point. In one embodiment, the user's voice is compared to all stored voice signatures, and access is permitted if the user's voice matches one of the voice signatures. In a preferred embodiment, the user account and the actual caller have been identified by the account number and the PIN. Thus the voice verification at step 72 requires the computer to compare the caller's voice against a voice signature that has been identified by the numbers previously given to the computer. The process of comparing one voice, the caller's voice, to the voice signature is less computer intensive than comparing the user's voice to all of the voice signatures.

The first attempt to verify the user's voice can use the voice sample provided when the account number and PIN were provided. If this test fails, the caller will be prompted to provide additional voice samples, such as by speaking a set of predetermined words or sentences. This new voice sample can then be compared to the voice signatures previously stored for this particular user. Preferably, the user is given three attempts to verify his or her voice. After the verification step 72, the computer moves to decision block 76. If the user's voice has been verified, the program moves through block 48 and returns to the program of FIG. 2. If the voice was not verified, it is determined that the user is not a valid user, and the program proceeds to step 78 and terminates the call.

The verification step 72 may involve more than simple voice verification. For example, if the caller's voice does not meet a first specified criteria for correlation with a voice signature, but it does meet a lesser criteria for correlation, there is a probability that the user is a valid user. However, because confidence level is low based on the inability to meet the first specified criteria for correlation, additional information is requested from the user. For example, the user may be requested to provide a mother's maiden name or a pet's name or some other type of private information that has previously been provided to the computer 16 and stored. If the user's voice meets the second lesser criteria for correlation and the user correctly answers the question for private information, the user will be identified as a valid user and allowed to access the system 10.

Each time a user accesses the system 10, a new voice sample is obtained and stored. A number of voice samples are stored over a period of time, and the most recent voice samples are used to verify the voice of a caller. Thus, if a user's voice changes over time, the voice signatures will also change over time, and the user will be able to provide a voice sample over time that meets either the first correlation criteria or the second lesser correlation criteria. Thus, if a user occasionally has a cold or a user's voice is affected by allergies, the samples collected over time will enable the user to successfully verify his or her voice over time.

Referring to step 74, if a particular user has not been enrolled in the system 10, the user will be given an opportunity to enroll. At this point, numerous voice samples of the user will be taken, and the user will be asked to provide spoken information or text information concerning such private things as a mother's maiden name. These voice samples and private information will be stored for future use. To verify that the new user is in fact a valid user, a separate verification technique must be performed. For example, a new password may be transmitted by a secure communications link back to the provider, and the new user may gain access by speaking the password during this session or during another session.

An alternate technique of unrolling a new user requires a previously authorized user to validate the new user. If this option is chosen, the new user is instructed to place a valid user on the phone, and the valid user is asked to provide his or her PIN and then the valid user's voice is verified against previously stored voice signatures as discussed above with regard to step 72. Once the old user has been verified as a valid user, the new user is accepted as a valid user as well. Thus, when a new nurse is employed at a doctor's office, another nurse at the doctor's office can enroll a new nurse as the valid user for the system 10 by allowing the new nurse to begin the process of accessing the system and then validating the new nurse at step 74. Once the new nurse is validated at step 74, her PIN and her voice signatures are stored for future access. After steps 74 or 76, the program returns through block 48 to the main program illustrated in FIG. 2.

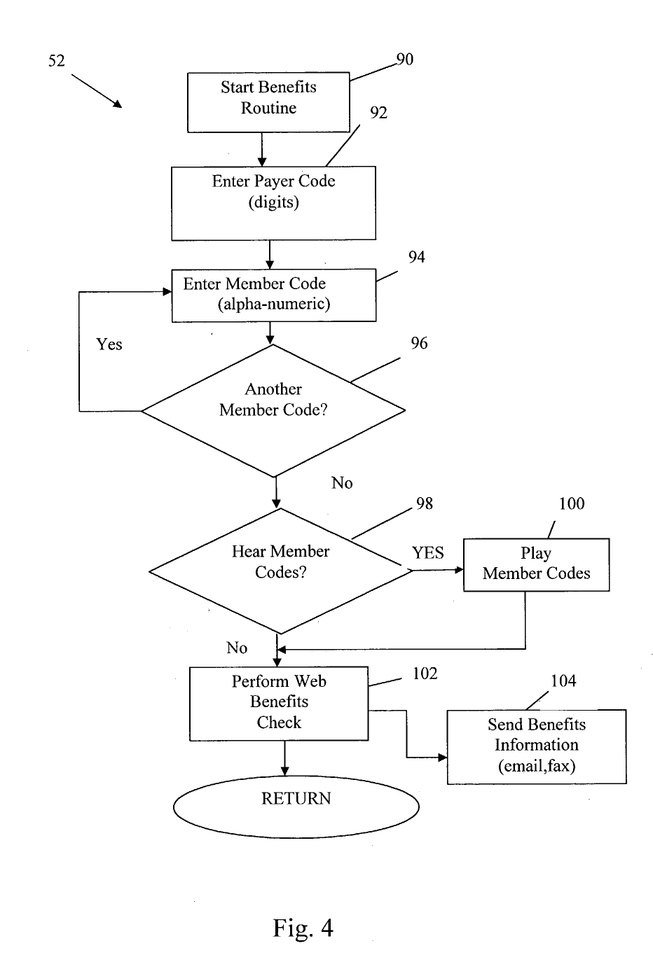

Once the user is validated by the process shown in FIG. 3, the program returns to the flow chart shown in FIG. 2 and the user must select a routine at step 50. Assuming the user chooses to do the benefits routine shown at step 52, the computer 16 will then perform the benefits routine that is illustrated in FIG. 4. The benefits routine starts at step 90 as illustrated in FIG. 4. At step 92, the user must enter a payer code, which is preferably an alphanumeric code and is most preferably a number code. The code is preferably entered by speaking the numbers and letters (or just the numbers) corresponding to the code. However, if desired, all or portions of the code may be provided through a push button input. The payer code identifies the particular organization, such as a health care organization, about which or from which the user desires information. The computer 16 has stored within it data correlating the payer codes with the identity of a payer, namely a benefit organization (such as a health care benefit organization), and using the data the computer 16 identifies the organization indicated by the particular payer code entered by the user.

The program then moves to step 94 and the user enters a member code, which is also called a person code or a patient code. The member code is again, preferably, an alphanumeric code and it is preferably entered by speaking the numbers and letters. A particular member (person or patient) is uniquely identified by the member code, and the computer 16 stores a plurality of member codes which is correlated to particular members and information about the members. Thus using the member code entered by the user, the computer 16 may ascertain the identity and additional information about the member corresponding to the member code that was entered.

At step 96, the computer 16 will prompt the caller as to whether he or she wishes to enter another member code. If the answer is yes, the caller will be prompted to enter another code and the process will continue moving from step 94 to step 96 and back again until all member codes are entered. At that point, the computer 16 moves to step 98 and prompts the user as to whether it would like to hear the member codes. By hearing the member codes, the user may verify that the correct codes were entered. If the user responds “Yes,” the process moves to step 100 and plays the member codes. If any of the codes were erroneous, the user is given an opportunity to correct the member codes. Preferably the payer codes and the member codes are entered by spoken voice and are interpreted by the computer. At step 100, the computer is replaying the member codes in a computer voice based on the translation or conversion of the user's voice to actual digital numbers. Thus, by listening to the member codes the user can check for his or her mistakes, and also mistakes made by the computer will also be determined.

Once the member codes are entered correctly, the computer 16 moves to step 102 and performs a benefits check to determine whether the member is entitled to benefits of an organization. In the health-care field, the computer 16 checks to determine whether a patient is entitled to benefits under an insurance policy, a managed care policy or other health-care policy. This benefits check may be based on an internal data base relating to a number of benefits organizations, or the computer 16 may access computers owned by the benefit organization and check to determine whether a particular person is in fact a member of a benefit organization and is entitled to benefits from the organization. Once the computer 16 has identified and verified the benefits available to a particular person (member or patient) the computer 16 then moves to step 104 and sends benefit information to the user/provider in a format specified by the provider in the user profiles 24. Thus, the benefits information may be sent by mail, fax, telephone message, e-mail, or otherwise in an order and with a specified amount of detail based upon the information provided in the user profiles 24.

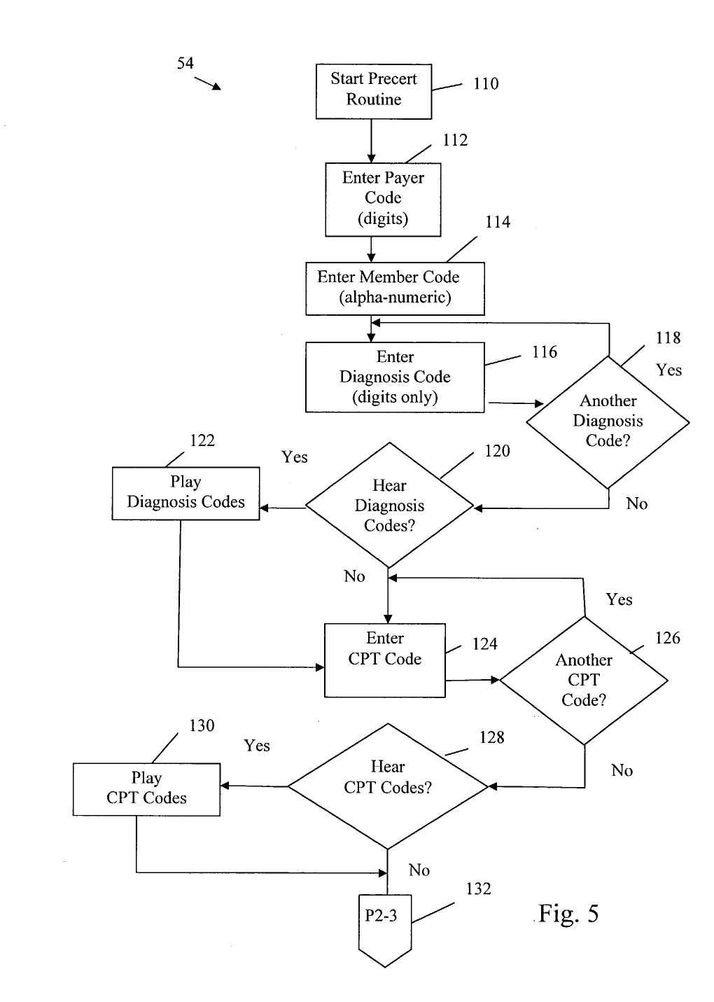

Referring now to FIGS. 5 and 2, if the user states that the pre-certification routine is desired, the pre-certification routine is started as indicated at step 110. The user first enters a payer code (preferably just digits) which identifies the payer (the benefit organization) as indicated previously. Next, the process moves to step 114 and the user enters a member code, preferably just one member code, which is an alphanumeric code that is preferably spoken. Alternatively, it could be entered using a phone push button or a computer push button input.

Then, the computer 16 moves to step 116 and the user enters diagnosis codes which are preferably just digits indicating the doctor's diagnosis of a patient's condition. Preferably the diagnosis codes are the standard diagnosis codes used in the United States by health care practitioners. Again, the preferred mode of entering the code is by spoken numbers. After one code is entered, the process moves to step 118 and the computer 16 prompts the user for additional diagnosis codes. If the user indicates that additional diagnosis codes for this member should be entered, the process returns to step 116 and additional diagnosis codes are entered in the manner stated previously. Once all diagnosis codes are entered, the program moves to step 120 and the computer 16 prompts the user to indicate whether he or she wishes to hear the diagnosis codes. If the answer is yes, the program moves to step 122 and the diagnosis codes are played to the user. The diagnosis codes may be played back as a voice file in the user's voice, or the codes may be interpreted and translated by computer 116 into numbers. In which case, the diagnosis codes will be played back to the user in a computer voice based upon the converted numbers. In either case, if the user detects that a diagnosis code is incorrect, the user may correct the diagnosis codes in response to prompting for such.

After the diagnosis codes have been fully entered and played, if desired, the program moves to step 124 and the user enters CPT codes corresponding to service actions that are desired to be performed for a particular member (patient). Probably the CPT codes are the standard codes used in the United States for identifying health care actions to be performed on a patient. After a CPT code is entered, step 126 is performed and the computer 16 asks the user whether additional CPT codes need to be entered. If the answer is “Yes,” the program moves back to step 124 and additional CPT codes are entered. Once all CPT codes for a particular member/patient are entered, the program moves to decision block 128 and prompts the user to state whether he or she wishes to hear the CPT codes. If the answer is “Yes,” the program moves to step 130 and plays the CPT codes. Again, the codes may be read back in the voice of the actual user, or the codes may be converted to text and the characters may be read back to the user in the voice of a computer indicating that the codes have been translated. As before, the user will be given an opportunity to correct codes that have been incorrectly spoken or incorrectly translated. Preferably, the user will be prompted to identify incorrect codes and to enter the correct code.

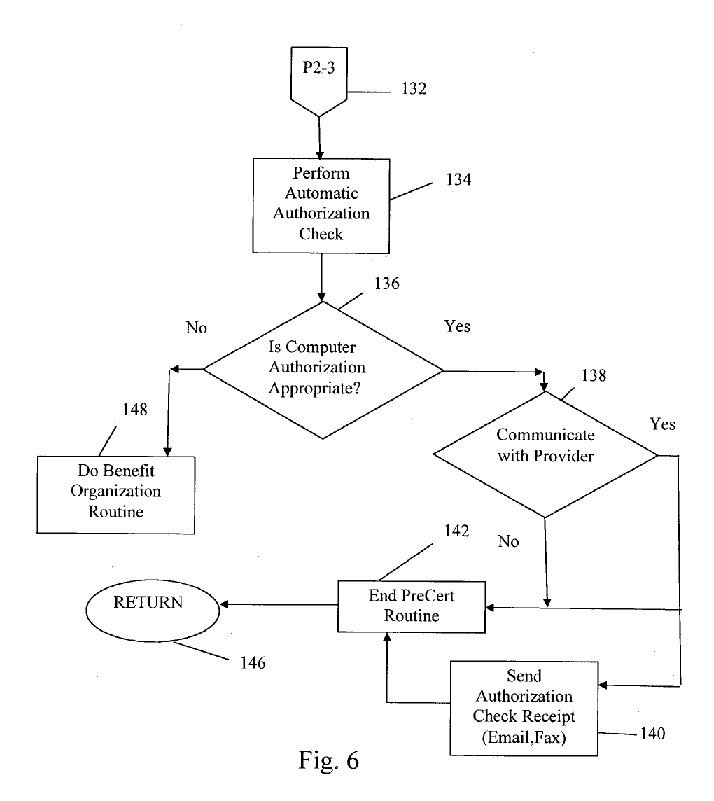

After all of the CPT codes have been entered correctly, the program continues with the flow chart shown on FIG. 6 as indicated by connector block 132. Referring to FIG. 6 at step 134, the computer 16 performs an automatic authorization check. This check may be performed using data locally on computer 16 or it may be performed by using data that is accessible over communication link 20. Thus, the automatic authorization check may be performed using data on the facilitator computers 22 or the benefit organization computers 26. Preferably, the computer first checks to see if the diagnosis codes and the CPT codes correlate or make sense according to a set of rules that are stored in one of the aforementioned computers 16, 22 or 26. These “correlation rules” are simple rules designed to make sure that the proposed health care action relates to the diagnosis in some rational, way. For example, if a diagnosis relates to the throat and the proposed action relates to the liver, it is likely that the action or the diagnosis have been inaccurately entered. In such case, the computer cannot automatically authorize the proposed action, but it will instead automatically inquire of the provider as to whether the diagnosis and the proposed action were accurately entered by the provider 12 or 14.

If the diagnosis codes correlate to the CPT codes, the computer 16 conducts a further check to determine whether the CPT codes require authorization. Some benefit organizations have standard rules stating that certain CPT codes do not require authorization. Despite these rules, health care providers routinely request authorization for those codes. When such request is received by the computer 16, an automatic authorization may be sent back to the provider. Preferably, a note is also sent back to the provider indicating that authorization is not required for this particular action and that it is not necessary to request authorization in the future.

If the diagnosis codes correlate to the CPT codes and if the action requires authorization, the computer 16 will then conduct an analysis to determine whether it can automatically authorize the action. To conduct this analysis, the computer 16 must consult a set of rules that was provided by the particular health care benefit organization in question. Each organization will have a different set of rules. For example, one particular health care organization may have a rule that a request to authorize a particular action can be automatically authorized provided that the action has not been performed on that patient within the last year. Thus, the computer 16 will check the CPT codes, reference the rules, and check the patient's history to see if the action has been performed in the last year. If not, the computer 16 will send a message to the provider automatically authorizing the action. As before, the message to the provider will be in the format requested by the provider. That is, for example, the authorization will be sent by email and by telephone if the provider has so requested in its user profiles.

The rules provided by the benefit organization may also include rules that identify automatically a pre-certification request that requires more information. For example, the benefit organization may require that a particular CPT code can be authorized only if two particular diagnosis codes are specified by the provider. If only one of the particular diagnosis codes is specified, the benefit organization may prefer to request additional information rather than simply deny coverage. In such case, the computer 16 would send a message to the provider 12 stating that only one diagnosis was given and this particular CPT code requires two specified diagnosis codes before it can be authorized. If the provider resubmits the pre-certification request with both diagnosis codes and the same CPT code, the action will be authorized unless other rules prevent it.

After the decision has been made at step 136 concerning automatic authorization, the program moves to step 138 and a decision is made as to whether communication with a provider 12 is necessary. The decision as to communication depends on the preferences of both the providers 12 and 14 and the rules provided by the benefit organization. For example, a particular provider may establish that for certain requested actions, he will receive a communication only if the pre-certification request has been denied. For such provider, a decision at step 138 would stop further communications with the benefit organization if automatic authorization for this code has been generated. Instead of sending an authorization, step 138 would block the transmission of the authorization and would move to step 142 ending the pre-certification routine.

As another example, one benefit organization may require that authorizations be sent to providers even when the provider is seeking pre-certification for an action that requires no pre-certification. Other benefit organizations may have the opposite rule. That is, if a provider requests pre-certification for an action that requires no pre-certification, this particular benefit organization may require that no authorization be given. In general, however, automated authorizations create a high confidence level for the provider and are simple and economical to provide from the perspective of the benefit organization. Thus, most benefit organizations and most providers will likely set their preferences to allow automatic authorizations and communications to the provider if at all possible. The objective from the standpoint of the benefit organization is to save the cost and expense of manually determining whether a particular action can be authorized. From the perspective of the provider, obtaining proof as to pre-certification (or authorization) is very important and the speed and accuracy of automatic authorization is greatly appreciated by the providers.

Assuming communication with a provider is appropriate, the program moves to step 140 and authorization is sent to the provider in the format requested by the provider. For example, a provider could request authorization in the form of a voice, authorization, and email, a fax or other form. The computer 16 will keep a record of all automatic authorizations and how they are sent. This is particularly important in the case of voice authorizations because a provider will typically not have the capability or the desire to store a voice file indicating that a particular action is authorized. Thus, storage of this type of voice authorization will help avoid conflicts between the benefit organization and the provider as to whether authorization was actually given. It is less important when faxes or emails are sent because the provider can easily keep copies of these types of transmission.

The decision at step 138 to communicate with a provider automatically sends the program to step 142 after step 140. Thus, a “Yes” decision in the pre-certification routine returns the computer 16 to the main program shown in FIG. 2 as indicated by Block 146.

The process for prompting a provider for information, obtaining the information, processing the information, making a determination and communicating the determination back to the provider can take a variety of forms and use a variety of language. An example is provided below of a simple telephone exchange between a representative of a provider 12 and a computer such as voice computer 16. In this example, the computer is referred to as “Legac-e” and the representative of the provider 12 is referred to as “Caller”. The speaker's identity is on the left side of the page, and the spoken words are on the right side. In this example, the “Pre-certification routine” is called the “Authorization routine”, and the “Authorization” takes the form of a statement indicating that no authorization is required along with a receipt confirming the statement. For most purposes, such receipt is equivalent to an authorization.

The spoken exchange is as follows:

Telephone Rings . . .

<Legac-e> Welcome to Legac-e VoiceWorks, please sign in.

<caller> 41237679595

<Legac-e> Which service would you like?

<caller> Authorization

<Legac-e> Payer code please

<caller> 1234

<Legac-e> Health Net Member Code

<caller> jkl123456789

<Legac-e> Speak diagnosis code. Finish by saying “go.”

<caller> 0270

<Legac-e> Next

<caller> 78001

<Legac-e> Next

<caller> 0039

<Legac-e> Next

<caller> Go

<Legac-e> You entered 3 diagnosis codes. Would you like to hear them?

<caller> No

<Legac-e> Speak action code. Finish by saying “go.”

<caller> 1104001

<Legac-e> Next

<caller> 1105501

<Legac-e> Next

<caller> 1105502

<Legac-e> Next

<caller> Go

<Legac-e> You entered 3 action codes. Would you like to hear them?

<caller> No

<Legac-e> Performing authorization check (pause)

<Legac-e> No authorization needed for these actions. Would you like a receipt?

<caller> Yes

<Legac-e> Would you like to use another service?

<caller> No

<Legac-e> Thank you for using Legac-e VoiceWorks. Good-bye.

The above example illustrates one way the invention may be implemented. There will be variations in the format and content depending upon the particular application, the particular providers and the particular voice computers and benefits organizations.

Referring again to step 136, if computer authorization is not appropriate because no rules were found that would allow computer authorization for a particular set of diagnosis codes and action codes, the program moves to step 148 and performs a benefit organization routine. The purpose of this routine is to transfer information and the decision making process to a benefit organization such as a health care organization.

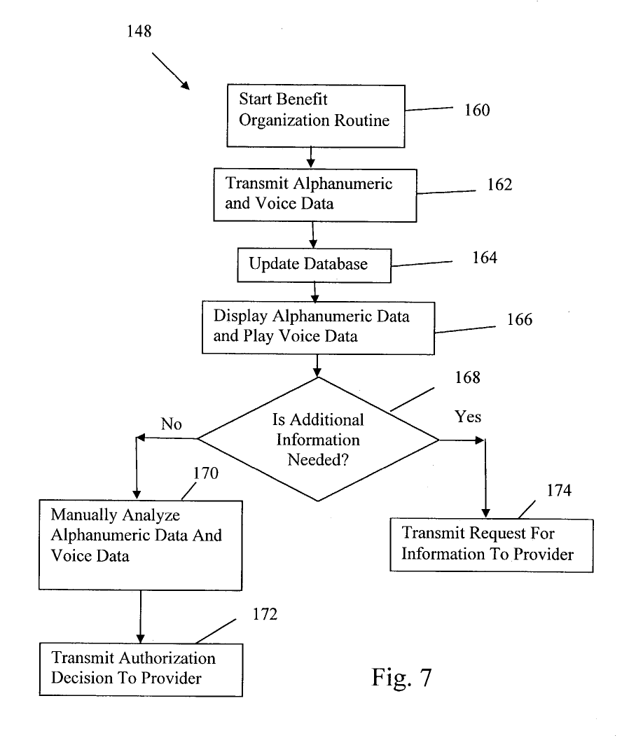

Referring to FIG. 7, a flow chart is shown that illustrates the action for authorizing or not authorizing a particular request by a provider. The process begins at step 160. Referring to FIG. 1, starting the benefit organization routine will typically involve the transfer of information from a facilitator computer 22 to a benefit organization computer 26 or 28 along with a request for authorization or pre-certification for a particular action, such as an action identified by a CPT code. The process of transmitting alphanumeric and voice data from computer 22 to computers 26 and or 28 is illustrated by step 162.

At step 164, the benefit organization computers 26 and 28 update their databases including the pay files 30 and 34 and the data files 32 and 36. At this point a decision is made by the benefit organization computers 26 and 28 as to how the pre-certification request will be handled. In some companies, the benefit organization computers 26 and 28 will have a set of rules to allow the computer to automatically authorize or refuse authorization for particular action codes or combinations of diagnosis codes and action codes. If so, the automatic authorization by computer may be handled in a manner similar to that described above.

In a more typical situation, the computers 26 and 28 determine that automatic authorization by computer is and not possible and proceed to step 170 to manually analyze alphanumeric data and voice data. At this point, there is a display of data that is generated from the alphanumeric data provided to the computers 26 and 28, or generated by the computers 26 and 28 based on voice files. In addition, the computer display will include a prompting to allow the user to press or click on a button to play back the voice. As indicated at step 168, the user analyzes the information first to determine whether additional information is needed. If the answer is “Yes” the user transmits a request for information to the provider. If the answer is “No” the process moves to step 170. Based on both visual data and audible data the user will make a decision and will transmit that decision to a provider in a format selected by the provider, which is indicated at step 172 but the decision will be received in a format selected by a provider. Such a decision may be transmitted by telephone, mail, fax, e-mail, wireless radio or other communication link.

Having described the system 10 in various forms as representative embodiments, it will be appreciated that the invention is capable of numerous rearrangements and substitutions of parts without departing from the scope of the invention as defined by the appended claims. The system 10 provides convenient information transfer by which a person may communicate by voice with a benefit organization concerning benefits available to a person. In certain circumstances, a person can communicate by voice with a computer and obtain information and decisions relating to benefits provided by a benefit organization, such as a health care benefit organization, directly from the computer without human intervention or action. Communication by voice enables voice verification and identification techniques to be used that greatly simplify security measures and increase the efficiency of implementing security measures. The system can also provides for efficient communication with persons working for the benefit organization who manually make decisions concerning benefits based upon the information provided by voice by a user or provider.

While health care provider organizations and health care benefit organizations can benefit from the system 10, it also has application to other types of organizations that involve one group providing services and another group providing benefits. The incentive for both groups is efficiency. Provider efficiency is enhanced by efficient communication with a benefit organization because less time is required to determine benefit information and benefit decisions. From the standpoint of the benefit organization, the system can eliminate the need for a human decision where a computer can automatically provide information, authorize actions, refuse authorization of actions, or automatically request additional information. Even when manual decision making is required, efficiency is increased because information is rapidly and conveniently displayed or played to a human user in a format that is familiar to the user. Storage efficiency is also increased because it is not necessary to convert voice messages to text messages for storage, either by manual typing or by voice recognition techniques. Instead, the voice files for at least a portion of the information may be stored in the format of a voice file.

In the context of voice communication to and from computers, the ability to convert information from one format to another and to know the order of the information is important. For example, even though a nurse is communicating with numerous health care benefit organizations, she is communicating the same information in the same order to all of the health care benefit organizations. Using the same order of the information makes the nurse more efficient in transferring that information. Likewise, when information is transferred back to the nurse from many different health care benefit organizations, the computers convert the information from a variety of formats to a single format that has been specified by the provider. Thus, the provider can quickly interpret the information because it is in the same order and format even though the information was generated by different companies in different formats.

The same advantage occurs when the health care benefit organization is receiving or sending information. The benefit organization can display the information and play the information in the same order and format even though the providers created the information in a variety of orders and formats. The computers change the order and format as desired as specified by the benefit organization. Likewise, the benefit organization can transmit the information in a format and order that it desires, knowing that each provider will receive the information in a desired format and order which has been previously specified by each provider.

In some instances, knowing the order of information will even help the computers increase efficiency. For example, when a computer receives a call from a particular caller number it will know the identity of the provider based on the caller number. Thus, based on the caller number, it will know the order of the information to be received, and it can anticipate what function it needs to perform. If the computer knows that only numbers will be used to provide information, it can anticipate receiving only numbers and interpret the information more efficiently. If the computer knows that it will receive characters and numbers, but no whole words, again it can interpret the information more efficiently.

Thus, it will be appreciated that the system 10 creates increased efficiency at both of the human level and the machine level.

What is claimed is:

1. An information transfer system for transferring information from and to a user about persons or entities and concerning benefits provided by at least one organization comprising:
user inputs enabling the user to input information including voice information into the information transfer system, the information corresponding to at least an identification of at least one s and an identification of at least one user,
at least one computer system for:
(a) receiving information including voice information from at least the user inputs,
(b) identifying the at least one user and producing user identification based on the information,
(c) identifying the at least one person or entity and producing person or entity identification based on the information,
(d) accessing benefits information corresponding to the person's or entity's benefits provided by the at least one organization, and
(e) comparing the person or entity identification to the benefits information and making automatic determinations for the person or entity concerning the benefits provided by the at least one organization for the person or entity, and
a computer system output for automatically transmitting the automatic determinations to the user concerning the benefits for the person or entity.

2. The information transfer system of claim 1, further comprising:
the computer system storing benefits information corresponding to person or entity's benefits provided by a plurality of organizations and comparing the person or entity identifications to benefits information of a plurality of organizations and making automatic determinations on behalf of a plurality of organizations for particular persons or entities concerning the benefits available to the particular persons or entities from the plurality of organizations, and
the computer system output for automatically transmitting the automatic determinations made on behalf of the plurality of organizations by the computers system to the user.

3. An information transfer system for transferring information about a person or entity from and to a provider comprising:
provider inputs enabling providers to input at least voice information into the information transfer system, the voice information corresponding to at least the identification of a person or entity and the identification of a provider,
at least one voice enabled computer system for:
(a) receiving at least voice information from the provider inputs,
(b) identifying at least one provider and producing a provider identification based on the voice information,
(c) identifying at least one person or entity and producing a person or entity identification based on the voice information,
(d) storing coverage information corresponding to benefits provided by an organization associated with persons or entities, and
(e) comparing the person or entity information to the coverage information and determining benefits information corresponding to benefits for the at least one person or entity, and
a computer system output for transmitting benefits information to a provider indicating whether a person or entity is eligible for benefits.

4. The information transfer system of claim 3 further comprising:
the provider inputs for providing voice information corresponding to at least a diagnosis of the person and a proposed action to be performed on the person,
the voice enabled computer system comparing the person information to the coverage information and producing authorization information indicating whether the proposed action is authorized, and
the computer system output for transmitting the authorization information to at least some providers for at least some proposed actions.

5. The information transfer system of claim 3 further comprising:
the provider inputs for providing voice information corresponding to at least a diagnosis of the person and a proposed action to be performed on the person,
the voice enabled computer system comparing the person information to the coverage information and producing authorization information indicating whether the proposed action can be automatically authorized by the computer system because either no authorization is required for a particular action or because the person information justifies the proposed action based on authorization criteria; and
the computer system output for automatically transmitting the authorization information to at least some providers for at least some proposed actions if the proposed action is justified based on the authorization criteria.

6. The information transfer system of claim 3 further comprising:
the provider inputs for providing voice information corresponding to at least a diagnosis of the person and a proposed action to be performed on the person,
the voice enabled computer system comparing the person information to the coverage information and producing authorization information indicating that automatic authorization by the computer system is not appropriate based on authorization criteria; and
the computer system output for automatically transmitting the authorization information to the organization that provides the benefits if authorization by the computer system of the proposed action is not appropriate.

7. The information transfer system of claim 3 further comprising:
the voice enabled computer system prompting the provider for information in a format specified by the provider and generating output information for the organization in a format specified by the organization, and
the computer system output transmitting the output information to the organization that provides the benefits.

8. The information transfer system of claim 3 when it the voice enabled computer system further comprises:
a voice computer system for receiving voice messages from a provider and converting at least some of those voice messages to text,
a facilitator computer system storing user profiles that contain information about the providers and the persons for whom benefits are provided by the organization,
a communications link between the voice computer system and the facilitator computer system for transferring information between the two computer systems, and
the facilitator computer system for receiving information from the voice computer system corresponding to the voice messages including text, and for processing the text to identify at least the patient, and for producing person information on based on the identity of the patient and the information stored in the user profiles.

9. The information transfer system of claim 3 wherein the voice enabled computer system further comprises:
a voice computer system for receiving voice messages from a provider and converting at least some of those voice messages to text,
a facilitator computer system storing user profiles that contain information about the providers and the persons for whom benefits are provided by the organization,
a communications link between the voice computer system and the facilitator computer system for transferring information between the two computer systems, and
the facilitator computer system for receiving information from the voice computer system corresponding to the voice messages including text, and for processing the text to identify at least the patient, and for producing person information on based on the identity of the patient and the information stored in that the user profiles,
an organization computer system for storing information about persons including coverage information for each person, and
a communications link between the facilitator computer system and the organization computer system for transferring information between the two computer systems, the organization computer system receiving at least person information from the facilitator computer system and the facilitator computer system receiving at least coverage information from the organization computer system.

10. The information transfer system of claim 3 wherein the voice enabled computer system further comprises;
a voice storage module for storing voice signatures corresponding to the voices of providers,
a voice analysis module for comparing the voice of a provider to the voice signatures and for making a determination concerning the identity of the provider based on the voice comparison, and
an access control module for allowing further access by a provider to the voice enabled computer system to thereby receive additional information from the provider, the further access being based upon the determination concerning identity.

11. The information transfer system of claim 10 wherein the voice analysis module receives information in text form as to the identity of the provider and then verifies the identity of the provider by comparing the provider's voice to a voice signature stored in the voice storage module.

12. The information transfer system of claim 10 wherein the voice analysis module identifies the provider by comparing the provider's voice to the voice signatures stored in the voice storage module.

13. The information transfer system of claim 3 when the voice enabled computer system prompts the provider to spell out certain information by stating the name of each number or character in the certain information.

14. The information transfer system of claim 3 wherein the provider input includes an alpha-numeric input device and the voice enabled computer system prompts the provider to input certain information through the alpha-numeric input device.

15. The information transfer system of claim 3 wherein the voice enabled computer system identifies the number called by the provider (the called number) and responsive to the called number determines the computer program that it will execute on a particular call.

16. The information transfer system of claim 3 wherein the voice enabled computer system prompts the provider to spell out certain information by stating the name of each number or character in the certain information and the voice enabled computer interprets and converts the certain information from a voice format into a text format.

17. The information transfer system of claim 3 when the voice enabled computer system prompts the provider to speak certain information in a normal speaking voice speaking numbers as single whole numbers and the voice enabled computer interprets and converts the certain information from a voice format into a text format.

18. The information transfer system of claim 3 further comprising:
the provider inputs providing voice information corresponding to at least a diagnosis of the person and a proposed action to be performed on the person,
the voice enabled computer system comparing the person information to the coverage information and producing authorization information indicating that automatic authorization by the computer system is not appropriate based on authorization criteria,
the computer system output automatically transmitting the authorization information to the health care organization computer system if automatic authorization of the proposed action is it not appropriate, and
the health care organization computer system transmitting a manual authorization decision to the health-care provider based on user inputs to the health care organization computer system.

19. An information transfer system for transferring information about a patient from and to a health care provider concerning health-care benefits provided by a health care organization comprising:
provider inputs enabling providers to transmit input information including at least voice information including a voice sample into the information transfer system, the input information corresponding to at least the identification of a person and the identification of a provider,
at least one voice enabled computer system for:
(a) receiving at least input information from the provider inputs,
(b) storing voice signatures with at least one voice signature being stored for each health care provider using the system, comparing the health care provider's voice sample with the stored voice signatures and allowing or disallowing further access to the information transfer system based on the comparison,
(c) identifying persons and producing person identifications based on the input information,
(d) storing coverage information corresponding to the health care benefits provided by a health care organization organization, and
(e) comparing the person information to the coverage information and determining health care benefit information for a particular person, and
a computer system output for transmitting health care benefit information to a provider.

20. The information transfer system of claim 19 wherein the voice enabled computer system receives voice information in alphanumeric form and converts at least part of the voice information to text form, identifies the provider based on the voice information in text form, and verifies the identity of the provider by comparing the provider's voice sample to a voice signature stored in the voice enabled computer system.

21. The information transfer system of claim 19 wherein the voice enabled computer system identifies the provider by comparing the provider's voice sample to the voice signatures stored in the voice enabled computer system, identifying the voice signature that corresponds to the provider's voice sample, and determines the identity of the provider based upon the identified voice signature.

22. The information transfer system of claim 19 wherein the voice enabled computer system is operable to perform a second test when further access to the information transfer system is disallowed based on the comparison of the voice sample to the voice signatures, the voice enabled computer system being operable to allow further access to the information transfer system based on the second test that requires the provider to input private information known to the provider but generally unknown to the public.

23. The system of claim 22 wherein the second the test further comprises a comparison of the provider's voice sample to the voice signature stored for a particular provider and allows access to the information transfer system if the provider's voice sample correlates to the stored voice signature based on a relaxed standard of correlation and the provider inputs the correct private information.

24. An information transfer system for transferring information about a patient from a health care provider concerning health-care benefits provided by a health care organization comprising:
provider inputs enabling providers to input information including a voice file containing information about patient into the information transfer system, the information corresponding to at least the identification of a patient and the identification of a provider,
at least one voice enabled computer system for:
(a) receiving at least voice information including a voice file from the provider inputs,
(b) identifying providers and producing provider identifications in a digital non-voice format,
(c) identifying persons and producing person identifications in a digital non-voice format,
(d) identifying a health care organization corresponding to each person identification,
(e) producing output information that includes digital non-voice information corresponding at least to patient identification and provider information and that includes at least a portion of the voice file,
a computer system output for transmitting the output information, and
a health care organization computer system for receiving, storing and displaying at least portions of the output information from the voice enabled computer system, the health care organization computer system storing at least a portion of the voice file.

25. The information transfer system of claim of 24 wherein the voice enabled computer system is further operable to receive a voice file containing alphanumeric characters and convert the alphanumeric characters to text form and identify the patient and the provider based on the alphanumeric characters in the voice file.

26. The information transfer system of claim 24 wherein:
the voice enabled computer system is operable for;
(a) identifying a provider and producing provider identification based on the voice information,
(b) identifying persons and producing person identifications based on the voice information,
(c) storing coverage information corresponding to the eligibility of persons for benefits provided by an organization, and
(d) comparing the person information to the coverage information and determining eligibility information indicating whether a particular person is eligible for benefits, and
the computer system output for transmitting eligibility information to a provider indicating whether a person is eligible for benefits.

27. The information transfer system of claim 24 further comprising:
the provider inputs for providing voice information corresponding to at least a diagnosis of the person and a proposed action to be performed on the person,
the voice enabled computer system comparing the person information to the coverage information and producing authorization information indicating whether the proposed action can be automatically authorized by the computer system because either no authorization is required for a particular action or because the person information justifies the proposed action based on authorization criteria.
the computer system output automatically transmitting the authorization information to at least some providers for at least some proposed actions if the proposed action is justified based on the authorization criteria.

28. The information transfer system of claim 24 wherein the voice enabled computer system further comprises:
a voice storage module for storing voice signatures corresponding to the voices of providers,
a voice analysis module for comparing the voice of a provider to the voice signatures and for making a determination concerning the identity of the provider based on the voice comparison, and
an access control module for allowing further access by a provider to the voice enabled computer system to thereby receive additional information from the provider, the further access being based upon the determination that was based on the voice comparison.

29. A method of certifying whether or not a health care organization covers an action that a medical service provider desires to perform on a patient, the method comprising:
receiving a call from a medical service provider at a call processing center;
prompting the medical service provider to provide identification information that identifies the medical service provider;
prompting the medical service provider to provide identification information that identifies the patient;
prompting the medical service provider to provide identification information that identifies an action that the medical service provider desires to perform for the patient;
receiving and storing the information received from the medical service provider in memory;
examining the information received from the medical service provider in conjunction with stored information associated with the patient and an associated health care organization to determine if the medical service provider is automatically certified to perform the action for the patient and automatically informing the medical service provider that the action is certified if appropriate;
forwarding the information provided by the medical services provider to the health care organization associated with the patient if the action is not automatically certifiable;
receiving certification information from the health care organization in response to the forwarded information; and
transmitting the certification information to the medical services provider.

30. An automated system for transmitting medical information between a medical services provider and health care organization, the system comprising:
an identification memory for storing identification information that identifies a user of the automated system as an authorized user of the automated system;
a caller identifier for identifying callers based upon the identification information stored in the identification memory;
a profile memory for storing multiple profiles wherein at least a portion of the profiles are associated with selected users of the automated system;
a voice response unit for answering an incoming call to the automated system, prompting a caller to enter identification information associated with the caller and prompting the caller to enter information in accordance with a format specified by the identification information;
a voice recognition unit for receiving voice signals and converting the voice signals into digital information;
a message storage memory for storing information received from callers;
an automated response unit for examining information provided by a caller, determining if an automated response can be provided to the caller, and providing an automated response to the caller if appropriate;
a reformatting unit for altering a format of received data that is to be sent to a third party in accordance with a profile associated the third party;
a message forwarding unit for forwarding information received from a caller to a selected third party; and
a reply unit for receiving a reply from a third party in response to a forwarded message and forwarding the reply to a designated party in a format selected by the designated party.

31. A method of transferring information between two parties, the method comprising:
identifying a sending party that wants to send a message to a receiving party;
prompting the sending party to enter information in a format associated with the sending party;
saving the information provided by the sending party;
examining the information to determine if an automated response can be provided to the sending party and providing an automated response if appropriate;
reformatting the information in accordance with a format specified by a profile associated with the receiving party and forwarding the reformatted information to the receiving party specified by the sending party if an automated response is inappropriate;
receiving a response to the reformatted information from the receiving party; and
forwarding the response from the receiving party to the sending party in a format specified by the sending party.

32. An information transfer system for transferring information about a patient from a health care provider concerning health-care benefits provided by a health care organization comprising:
provider inputs enabling providers to input information including a voice file containing information about patient into the information transfer system, the information corresponding to at least the identification of a patient and the identification of a provider,
at least one voice enabled computer system including one or more computers for:
(a) receiving information from the provider including at least voice information including a voice file from the provider inputs,
(b) identifying providers and producing provider identifications in a digital non-voice format,
(c) identifying patient and producing patient identifications in a digital non-voice format,
(d) identifying a health care organization corresponding to each patient identification and producing health care organization identifications,
(e) storing voice signatures with one of the the voice signatures corresponding to each provider,
(f) identifying a particular voice signature corresponding to the provider of identification,
(g) comparing the particular voice signature to the voice file of the provider and determining whether there is a correlation between the particular voice signature and the voice file based on correlation criteria,
(h) allowing further access to the information transfer system when there is sufficient correlation between the particular voice signature and the voice file to satisfy the correlation criteria,
(i) disallowing further access to the information transfer system when there is insufficient correlation between the particular voice signature and of the voice file to satisfy the correlation criteria,
(j) storing a plurality of actions including an eligibility action and a pre-certification action,
(k) prompting the provider by voice to choose between one of a plurality of actions, receiving a choice from the provider corresponding to a chosen action and performing the chosen action,
(l) when the eligibility action is chosen, determining whether a patient is eligible for health care benefits based upon the patient identification and the health care organization identification and producing an automatic eligibility determination,
(m) when the pre-certification action is chosen, prompting the provider by voice to provide at least a diagnosis and at least an action code, determining whether a particular action may be automatically authorized for a patient based on the diagnosis code and the action code, and producing and automatic authorization determination, and
(n) based on the automatic authorization determination, generating an automatic authorization message for the provider or an authorization request for the health care organization,
a voice enabled computer system output for transmitting to the provider automatic eligibility determinations and automatic authorization messages and for transmitting to the health care organization patient identifications, provider identifications, diagnosis codes, action codes, at least a portion of the voice file, and authorization requests,
a health care organization computer system including a database for receiving information from the voice enabled computer system and for storing in the database alphanumeric characters based on at least one of the patient identification, the provider identification, the diagnosis code, and the action code, and for storing in the database at least a portion of the voice file,
a user input for providing manual inputs into the health care organization computer system,
a health care organization display for displaying at least some of the alphanumeric characters stored in the database,
a health care organization sound output for audibly playing at least a portion of the sound file; and
health care organization computer output for transmitting to the provider information concerning patients including at least some manual authorizations of actions based on the diagnosis codes, the action codes and the manual inputs.
